(19) United States
(12) Patent Application Publication
(10) Pub. No.: US 2026/0112531 A1
(43) Pub. Date: Apr. 23, 2026

(54) Wafer-Bonded Inductors for Power Systems

(71) Applicant: Northeastern University, Boston, MA (US)

(72) Inventors: Vincent HARRIS, Sharon, MA (US); Parisa ANDALIB, Malden, MA (US)

(21) Appl. No.: 19/111,119

(22) PCT Filed: Oct. 10, 2023
(86) PCT No.: PCT/US2023/034863

§ 371 Date: Mar. 12, 2025

Related U.S. Application Data
(60) Provisional application No. 63/414,436, filed on Oct. 7, 2022.

(51) Int. Cl. H01F 27/28; H01F 10/20; H01F 10/24; H01F 41/04; H01F 41/34

(52) U.S. Cl. CPC H01F 27/2804; H01F 41/046; H01F 41/34; H01F 10/205; H01F 10/24; H01F 2027/2809

(57) ABSTRACT

Wafer-bonded inductors, transformers, and related electronic components can be used in power electronics and provide low conduction loss in the MHz-GHz frequency range. The wafer bonding fabrication process and its thermal requirements offer relatively simple and low cost manufacturing. The resulting devices offer a unique combination of high power handling at high frequencies and small form factor.

### CROSS REFERENCE TO RELATED APPLICATIONS

This application claims the priority of U.S. Provisional Application No. 63/414,436 filed 7 Oct. 2022, the whole of which is hereby incorporated by reference.

### BACKGROUND

Low-frequency inductors typically take the form of toroid, C-, or E-cores. These inductors have the benefit of supporting high power loads, but their form factors have precluded attempts to miniaturize circuitry and systems. Core materials have changed as a function of frequency, as depicted in FIG. 1A, which illustrates the interactions among materials, devices, and systems, technology pull, and form factors. Power inductor components, such as convertors, filters, transformers, and the like, have been based on SiC- and GaN-based switch mode power supplies, amplifiers, and AC-DC and DC-DC converters, and have found use in data centers, buildings, defense land vehicles, and ship-borne and air-borne platforms. For such platforms, the use of magnetic materials in power storage or conversion devices with properties such as tailored permeability, high saturation induction, and low core losses can lead to excellent performance in small form factors. At lower frequencies such as less than 100 kHz, the typical magnetic inductor materials are steels (e.g., Si-steels or Co-steels), amorphous metals (e.g., METGLAS), and nanocrystalline metals (e.g., FINEMET or NANOPERM), which possess very high permeabilities and saturation inductions, but typically have large form factors that stymie attempts at volumetrically efficient packaging. However, these metals, or semimetals, with electrical resistivities of p˜150-300 μΩ-cm, experience significant conduction losses that limit applications to frequencies of several 10′s of kHz.

For frequencies in the 100 kHz to 1 MHz range, excessive conduction losses in metallic systems require more insulating magnetic materials such as magnetoceramics. Magnetoceramics have moderate permeabilities with substantially lower saturation induction but have much higher electrical resistivities that allow for lower losses at higher operational frequencies. In this context, magnetoceramics include garnets, spinels, and hexaferrites, with spinels being the crystal structure of choice for most inductor applications below 10 MHz.

The form factors and other properties of various state of the art inductor devices are shown in FIG. 1B. Toroidal core inductors can be mounted on printed circuit boards (PCBs) and have high power handling capability; however they have a large form factor and limited frequency range. Planar inductors can be integrated into PCBs and have a smaller form factor; however, they have limited frequency range and power handling capability. Low temperature co-fired ceramic (LTCC) inductors can have a small form factor, but they have limited inductance and power handling capability. The use of LTCC processing protocols for high power and high current applications is limited by the small cross-sectional areas of screen-printed conductors, which create high electrically resistive paths. The thickness of LTCC laminates is limited to less than 2 mm, as greater thicknesses result in cracking or delamination upon sintering. Thin film inductors can be integrated into CMOS fabrication, have small form factor, and are capable of high frequency operation; however, they have limited inductance and power handling, and their fabrication is costly.

With the advent of wide bandgap semiconductor-based power electronics, there is a need for inductors that can support high power loads and operate above 1 MHz. It would also be advantageous to develop such inductors in small form factors. However, to date such needs have not been met.

### SUMMARY

The present technology provides wafer-bonded inductors and related components for use in power electronics with low conduction loss in the GHz range and having small form factors. The technology is unique in its ability to handle high power loads at high frequencies. No other existing technology provides these benefits. Furthermore, the fabrication process and its thermal requirements offer relatively simple and low cost manufacturing.

Compared to previous inductor technologies, the present technology offers very high performance, including the ability to handle high power densities at high frequencies (>1MHz), owing to the use of high density magnetoceramic tiles, leading to high Q factor devices. High power densities are also supported by the use of thick copper coil dimensions, such as about 10 to 100 micrometer thickness. The fabrication process results in tiles or dies of, for example, 1×1×1 cm, allowing for volumetrically efficient packaging of power systems. Larger tiles will support higher power densities than smaller. A baseline inductor device of the present technology, made using electroplated Cu metal, can handle 25 watts of power; an intermediate scale inductor, made using stamped Cu coil structures can handle up to 100 watts; and a scaled up device can handle up to 10 kilowatts. Processing cost can be reduced due to economy of scale practices. Uses of the present technology include for all types of transformers, AC-DC, DC-DC, and AC-AC convertors, low pass and high pass filters, inductors, and other components of utility for power electronic technologies.

Further advantages of the present technology include the following. It is compatible with a wide range of adhesives which can be adjusted as required for different electronic components. Fabrication can be performed at vacuum or using different atmospheric gases. The process is simple and low cost. The wafer bonding temperature can be not greater than about 300° C., and a variety of wafer materials can be used. The fabrication method can be performed in the absence of electric voltage and current. The fabrication can compensate for or remove surface non-uniformities and contamination. Fabrication is integrated circuit (IC) compatible. The devices are chemically resistant. Devices can be made with high transparency.

The technology can be further summarized with the following list of features.
1. A wafer-bonded inductor, comprising:
   (i) a non-magnetic substrate;
   (ii) two or more magnetic layers disposed as a stack on the substrate;
   (iii) a three dimensional metallic coil structure disposed within the stack; and
   (iv) a first contacts electrically connected to a first end of the coil structure and a second contact electrically connected to a second end of the coil structure.
2. The wafer-bonded inductor of feature 1, wherein the substrate comprises or consists of a material selected from the group consisting of polymers, semiconductors, wide bandgap semiconductors, GaN, GaO, SiC, diamond, graphite, graphene, carbon nanotubes, and combinations thereof.
3. The wafer-bonded inductor of feature 1 or 2, wherein the two or more magnetic layers each comprise or consist of a magnetoceramic material, such as a spinel, ferrite, garnet, hexaferrite, or any combination or composite thereof.
4. The wafer-bonded inductor of any of the preceding features, wherein the two or more magnetic layers each comprise or consist of a high density ferrite material comprising a continuous crystalline structure, such as a ferrite material having a density of at least 95%, at least 98%, or at least 99% of a theoretical maximum for the ferrite material.
5. The wafer-bonded inductor of feature 3 or feature 4, wherein the ferrite is Ni₁₋ₓZnₓFe₂O₄ or Mn₁₋ₓZnₓFe₂O₄.
6. The wafer-bonded inductor of feature 3, wherein the magnetoceramic material comprises Cu, Ti, Mg, Li, Co, or any combination thereof.
7. The wafer-bonded inductor of any of the preceding features, wherein the stack of magnetic layers comprises layers having different magnetic permeabilities.
8. The wafer-bonded inductor of any of the preceding features, wherein the different magnetic permeabilities form a gradient from lower magnetic permeability at a center of the stack to higher magnetic permeability towards top and bottom of the stack.
9 The wafer-bonded inductor of any of the preceding features, wherein the different magnetic permeabilities form a gradient from higher magnetic permeability at a center of the stack to lower magnetic permeability towards top and bottom of the stack.
10. The wafer-bonded inductor of any of the preceding features, wherein the stack does not comprise a printed circuit board.
11. The wafer-bonded inductor of any of the preceding features, wherein the three dimensional metallic coil structure comprises a metal selected from the group consisting of gold, silver, copper, aluminum, chromium, titanium, platinum, palladium, and combinations thereof.
12. The wafer-bonded inductor of any of the preceding features, wherein the three dimensional metallic coil structure comprises a plurality of metal structures disposed at one or more interfaces between magnetic layers and one or more metal vias connecting the metal structures between the interfaces.
13. The wafer-bonded inductor of any of the preceding features, further comprising an interface layer disposed between two or more adjacent magnetic layers of the stack of magnetic layers.
14. The wafer-bonded inductor of feature 13, wherein the interface layer comprises an adhesive, such as a polymer adhesive, a magneto-dielectric paste that has both permeability and permittivity, and/or magnetic or non-magnetic particles, such as ferrite nanoparticles.
15. The wafer-bonded inductor of any of the preceding features, comprising at least one pair of adjacent magnetic layers bonded together by direct wafer bonding without the use of an interface material or interface layer.
16. The wafer-bonded inductor of any of the preceding features, further comprising one or more additional metallic structures disposed between the magnetic layers, the additional metallic structures not in electrical contact with said coil structure.
17. The wafer-bonded inductor of feature 16, wherein the additional metallic structures are configured as heat sink structures, and wherein the heat sink structures are coupled with extensions leading out of the stack and configured for coupling to one or more heat disposal structures.
18. The wafer-bonded inductor of feature 17, wherein the heat sink structures form bands disposed along a length direction of the stack of magnetic tiles.
19. The wafer-bonded inductor of feature 16, wherein the additional metallic structures are configured as two sets of capacitive plates, each set comprising one or more capacitive plates electrically connected to a common contact.
20. The wafer-bonded inductor of feature 19 configured as a filter and further comprising dielectric material plates disposed between pairs of capacitive plates.
21. The wafer-bonded inductor of any of the preceding features, configured for operation with a Q value from about 1 to about 1000 and in a frequency range of at least 1 GHz, at least 2 GHz, at least 3 GHz, at least 4 GHz, at least 5 GHz, or at least 10 GHz.
22. The wafer-bonded inductor of any of the preceding features, further comprising a non-metallic encapsulation layer disposed on the stack of magnetic layers, wherein the encapsulation layer covers the conductive metallic structures and magnetically isolates the three dimensional metallic coil structure.
23. The wafer-bonded inductor of any of the preceding features having a rectangular form.
24. A wafer-bonded transformer, comprising:
   (i) a first wafer-bonded inductor of any of the preceding features;
   (ii) a second wafer-bonded inductor of any of the preceding features, wherein the non-magnetic substrate of the second wafer-bonded inductor is disposed on an uppermost magnetic layer of the first wafer-bonded inductor; and
   (iii) a top non-magnetic substrate disposed on an uppermost layer of the second wafer-bonded inductor.
25. A method of fabricating a wafer-bonded inductor, the method comprising the steps of:
   (a) providing a non-magnetic substrate, a plurality of tiles, the tiles comprising or consisting of a magnetic material, a conductive metal, and optionally an interface material;
   (b) bonding a first of said tiles to the substrate;
   (c) depositing the conductive metal to form a first patterned metallization layer on a surface of the first tile opposite the substrate;
   (d) optionally applying the interface material to coat the first tile and first patterned metallization layer;
   (e) forming vias in a second of said tiles according to pattern suitable for alignment with selected structures of the first patterned metallization layer;
   (f) bonding the second tile to the first tile, whereby the vias align with said selected structures;
   (g) depositing the conductive metal on a surface of the second tile opposite the first metallization layer, whereby the metal fills the vias, forms a second patterned metallization layer, and forms a continuous conductive pathway between the first metallization layer and the second metallization layer;
   (h) repeating steps (d)-(g) to deposit a third and optionally further tiles, vias, and metallization layers, thereby forming a stack of magnetic material tiles and a three-dimensional coil structure embedded within the stack of magnetic material tiles, with first and second exposed electrical contacts electrically connected with first and second ends of the coil structure.
26. The method of feature 25, wherein the plurality of tiles each comprise or consist of a magnetoceramic material, such as a spinel, ferrite, garnet, hexaferrite, or any combination or composite thereof.
27. The method of feature 26, wherein the plurality of tiles each comprise or consist of a high density ferrite material comprising a continuous crystalline structure, such as a ferrite material having a density of at least 95%, at least 98%, or at least 99% of a theoretical maximum for the ferrite material.
28. The method of feature 26 or feature 27, wherein the ferrite is Ni₁₋ₓZnₓFe₂O₄ or Mn₁₋ₓZnₓFe₂O₄.
29. The method of feature 26, wherein the magnetoceramic material comprises Cu, Ti, Mg, or Co.
30. The method of any of features 25-29, wherein the plurality of tiles comprises magnetic materials having different magnetic permeabilities.
31. The method of feature 30, wherein the different magnetic permeabilities of adjacent tiles in the stack form a gradient from lower magnetic permeability at a center of the stack to higher magnetic permeability towards top and bottom of the stack, or from higher magnetic permeability at the center of the stack to lower magnetic permeability towards top and bottom of the stack.
32. The method of any of features 25-31, wherein the conductive metal is selected from the group consisting of gold, silver, copper, aluminum, chromium, titanium, platinum, palladium, and combinations thereof.
33. The method of any of features 25-32, wherein the interface layer comprises an adhesive, such as a polymer adhesive, a magneto-dielectric paste that has both permeability and permittivity, and/or magnetic or non-magnetic particles, such as ferrite nanoparticles.
34. The method of feature 33, wherein step (d) is performed and the interface layer is formed using a powder or paste comprising a ferrite.
35. The method of any of features 25-34, wherein the bonding of step (b) and/or step (f) in at least one instance comprises direct wafer bonding without the use of an interface material, adhesive material, or interface layer.
36. The method of any of features 25-35, further comprising depositing one or more additional metallic structures disposed between the magnetic tiles, the additional metallic structures not in electrical contact with said coil structure.
37. The method of feature 36, wherein the additional metallic structures are configured as heat sink structures, and wherein the heat sink structures are coupled with extensions leading out of the stack and configured for coupling to one or more heat disposal structures.
38. The method of feature 36, wherein the additional metallic structures are configured as two sets of capacitive plates, each set comprising one or more capacitive plates electrically connected to a common contact.
39. The method of any of features 25-38, further comprising fabricating a non-metallic encapsulation layer on the stack of magnetic layers, wherein the encapsulation layer covers the conductive metallic structures and magnetically isolates the three dimensional metallic coil structure.
40. The method of any of features 25-39, wherein the tiles and the resulting wafer-bonded inductor have a rectangular form.
41. A circuit or device comprising the wafer-bonded inductor of any of features 1-24, or the wafer-bonded inductor made by the method of any of features 25-40.

### BRIEF DESCRIPTION OF DRAWINGS

FIG. 1A is a schematic diagram showing prior art technologies as they relate to technology pull, barriers to market insertion, and state of the technology in terms of material options and device configuration. FIG. 1B shows a comparison of several prior art inductor technologies.

FIG. 2 shows how performance factor (PF=(f×Bmax) at Pv=500 mW/cm³) varies as a function of frequency for several commercially available ferrites. Symbols indicate maximum PF for each material.

FIG. 3A illustrates four steps in the fabrication of high-density polished ferrite tiles: pressing a ferrite powder to form a green compact, sintering the compact, lapping, and polishing. FIG. 3B shows a schematic illustration of a process for the fabrication of a wafer-bonded and embedded solenoid-type inductor of the present technology. FIG. 3C shows a finished wafer-bonded inductor device. FIG. 3D shows a finished device with cross-sectional view.

FIG. 4 shows several different embodiments of embedded metallic coil shapes for forming high-power, low form factor, wafer-bonded inductors.

FIG. 5 depicts an example of a wafer-bonded inductor device having gradients of permeability throughout the stack. In this example, the gradient is from lower permeability at the center to higher permeability at the top and bottom.

FIG. 6 is a schematic illustration of a wafer-bonded inductor device having heat sinking straps embedded at interfaces between ferrite tiles of the stack and extending from the stack for connection with heat dissipation structures.

FIG. 7 is a schematic illustration of an example of a transformer device of the present technology.

FIG. 8A shows a schematic illustration of a high pass filter device. FIG. 8B shows the equivalent circuit diagram of the device depicted in FIG. 8A. FIG. 8C shows a schematic illustration of a high pass filter device. FIG. 8D shows the equivalent circuit diagram of the device depicted in FIG. 8C.

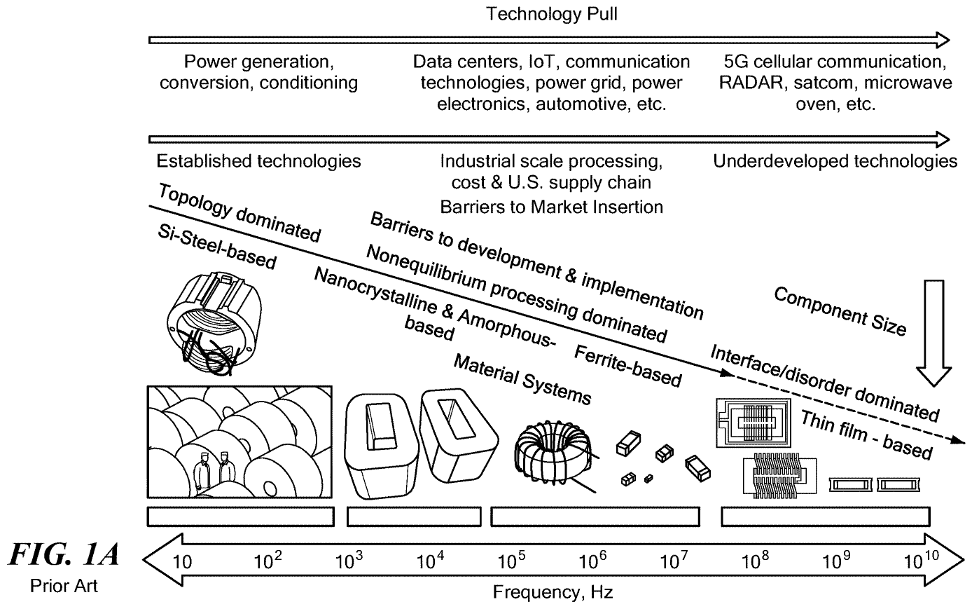

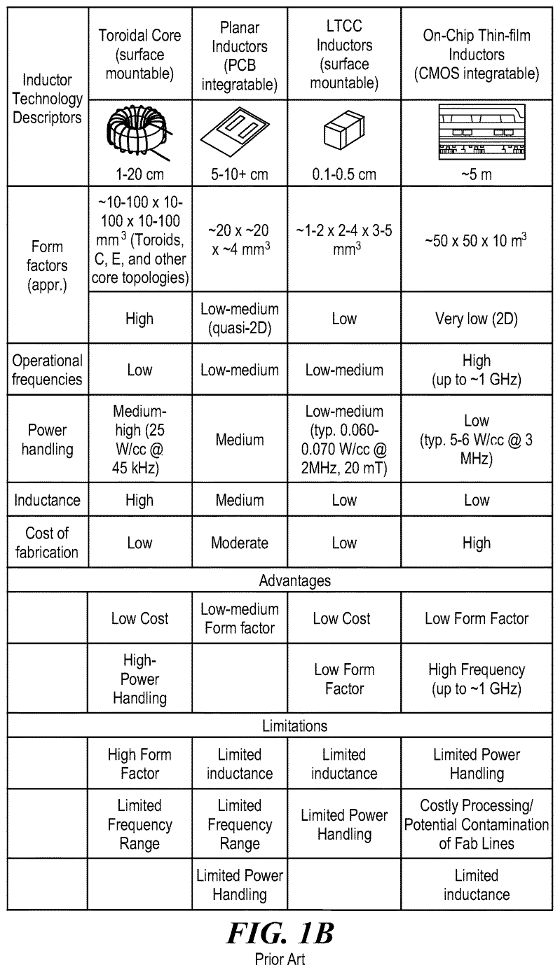

### DETAILED DESCRIPTION

The present technology provides an innovative solution for the configuration and fabrication of small form factor inductor components based on wafer bonding. The inductor devices are capable of supporting power generation, conversion, and conditioning functions at MHz and GHz frequencies, and are capable of high power handling capacity.

The fabrication is based on wafer bonding of prefabricated high density tiles containing a magnetic material or composite material to form a stack of tiles that are bonded to effectively complete magnetic circuits established by a metallic coil. The stack of magnetic material tiles encapsulates a continuous, three-dimensional metallic coil structure built up from patterned metal layers deposited at tile interfaces and connected vertically by metallic vias. The combined structure forms an easily fabricated inductor device that is capable of high power handling and, with appropriate selection of the magnetic material, is also capable of providing a high quality factor (Q) at high frequencies.

Previous inductor fabrication technologies (e.g., LTCC) have employed magnetic materials, such as ferrites, as a powder or a compacted powder. Such materials are of relatively low density and result in devices having low Q, however. The present technology instead utilizes pre-fabrication of high density magnetic material tiles that require high temperature to produce, but can be readily assembled using the much lower temperature conditions required for wafer bonding. The devices produced have a higher Q, higher permeability, and lower losses at high frequency. Further, the design of the metallic coil structures used in the present technology allows them to be scaled as needed for high power applications.

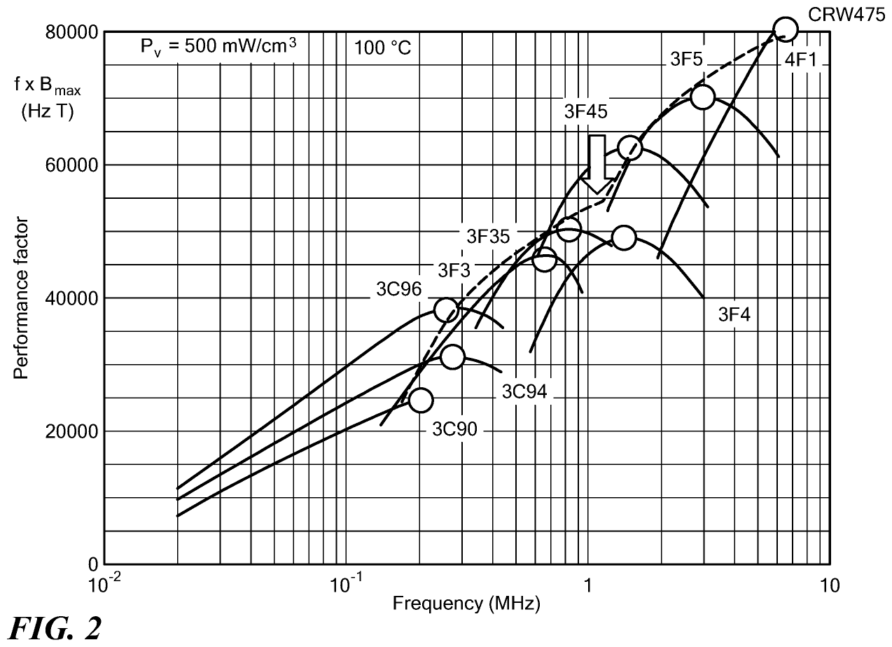

Various magnetic materials, such as magnetoceramic materials, are available for use in making the magnetic tiles required to fabricate the present wafer-bonded inductors. In FIG. 2, the performance factors of selected ferrites are plotted as a function of frequency. The materials cover a wide frequency range. There is a natural transition near 1 MHz, where manganese zinc ferrites (MZFO) transition to nickel zinc ferrites (NZFO); see Ferroxcube 3F35 to 3F45 at ferroxcube.home.pl/prod/assets/powapp.htm. Comparison of performance factors of these commercial off-the-shelf products indicate a rise in the performance factor of MnZn-ferrite up to 0.5 MHz where it then declines signaling its limiting operational frequency of ˜1 MHz. Performance beyond these frequencies, requires other magnetic materials, such as NiZn-ferrite or CoNiZn-ferrite, which have higher resistivity at the expense of permeability and saturation magnetic field (i.e., power handling capability). NiZn-ferrite is commonly used for communication applications since these materials have lower Bs and have limited power handling capability. These examples point out that a variety of commercially available materials with known properties are available and can be selected for use in making tiles for fabricating wafer-bonded inductors.

In addition to ferrites, other magnetoceramic materials that can be used to form the tiles for wafer-bonded inductors include spinels, garnets, and hexaferrite, as well as any combination or composite of these in conjunction with ferrites. Preferred ferrites are Ni₁₋ₓZnₓFe₂O₄ or Mn₁₋ₓZnₓFe₂O₄. optionally containing small amounts of Cu, Ti, Mg, and/or Co. Highly preferred are ferrites in form of sintered tiles having a continuous crystalline structure (i.e., not a compacted powder or any particulate form such as nanoparticles), and ferrite materials having a density of at least 90%, at least 95%, at least 98%, or at least 99% of their theoretical maximum density. Magnetic materials can be selected based on their functional properties, such as performance factor, quality factor, permeability, permittivity, low loss at desired operation frequency, and the like.

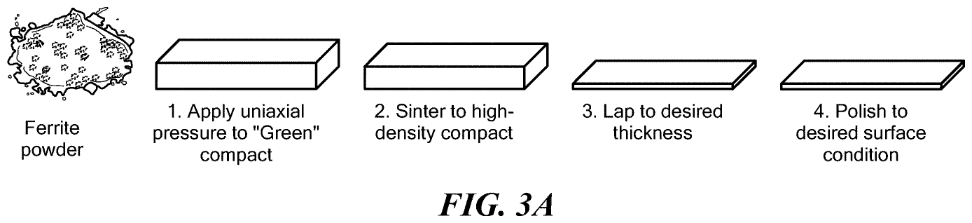

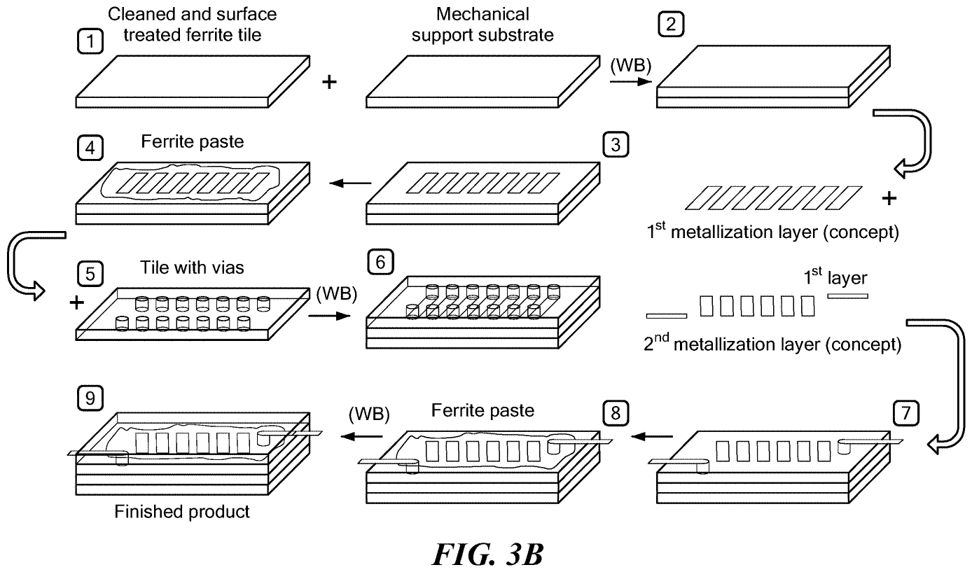

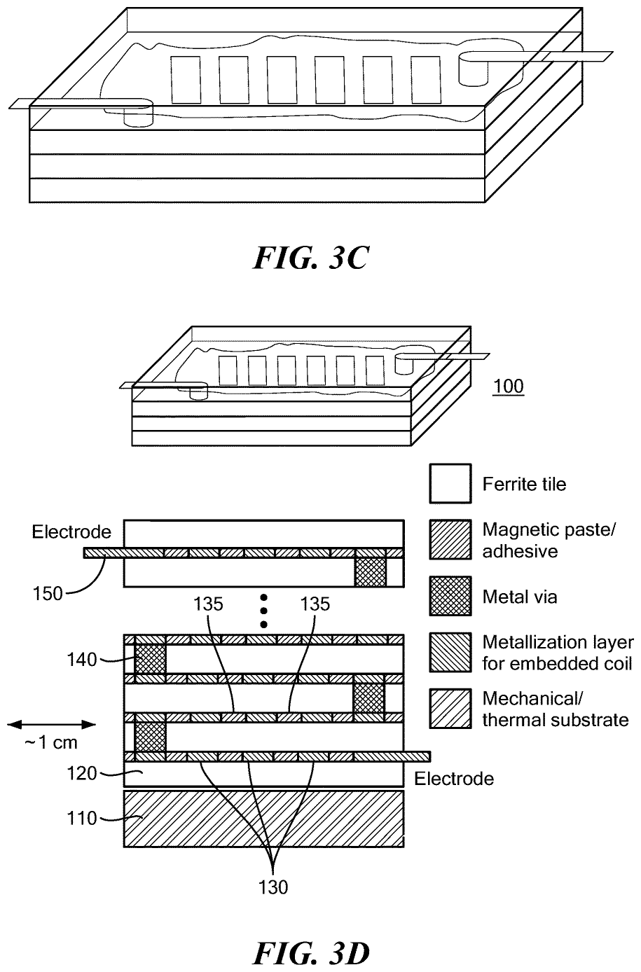

The processing steps of the present wafer-bonding technology are presented in FIGS. 3A and 3B. FIG. 3A illustrates traditional ceramic processing steps used to produce high-Q ferrite tiles. The steps include: creating a green compact from a ferrite powder or other suitable magnetic material, sintering the green compact to a high density, grinding and lapping or cutting to the desired thickness, and polishing to the desired surface roughness. The finished polished ferrite tiles are key materials for the wafer bonding inductor fabrication process described in FIG. 3B. The wafer bonding process encapsulates one or more electrically conductive inductor coils in a stack of bonded tiles that contain or consist of a magnetic material, such as a ferrite. The finished wafer-bonded inductor device can be configured, for example, as a lumped element component for drop-in or as a surface-mounted inductor component.

The process shown in FIG. 3B requires that the tile surface be prepared and cleaned for bonding and receiving metallic layers. The next step involves bonding of a first tile to a mechanical support substrate. The substrate can be any nonconductive or semiconducting material, including a ceramic, organic polymer, silicon, silicon dioxide, wide bandgap semiconductors such as GaN, GaO, or SiC, diamond, graphite, graphene, carbon nanotubes, and combinations thereof. Bonding to the substrate can be performed using an adhesive, metal adhesion layer, a dielectric material, or direct bonding achieved by application of high temperature and pressure. The first metallization layer is then applied on the surface of the first tile opposite the side attached to the substrate. The design or pattern of the metallization layer is selected to form a portion of a three-dimensional metallic coil in the completed inductor structure. Metallization layer pattern can be applied, for example, by screen printing or by photolithography to create trenches for depositing the metal by known techniques. Optionally, a paste containing ferrite particles or other magnetic material can be applied over the metallization layer to improve magnetic continuity and/or bonding with the next tile. A second tile preferably contains vias prepared at selected locations to provide electrical continuity with further metallization layers. Conductive metal is applied onto the second tile and to fill the vias, according to a pattern, most likely a different pattern from the pattern of the first metallization layer, so as to complete the three-dimensional conductive coil structure, or to provide the next segment of the coil structure. Additional tiles, vias, and metallization layers can be applied using similar steps until the coil structure is complete. Electrical contacts are provided at each end of the coil structure, and optionally leads extended out from the stack at desired locations for connection with a circuit. Preferably, an encapsulation layer or covering is applied over the inductor stack. with contacts or leads exposed outside the covering.

A finished wafer-bonded inductor device is shown in FIG. 3C. FIG. 3D shows the same device (100) at the top of the figure, and a cross-section of the device below. First ferrite tile 120 is bonded to substrate 110. Metallization layer structures 130 are deposited onto the surface of the ferrite tile and form part of the coil structure. Magnetic paste and/or adhesive 135 fills gaps within the metallization layer and promotes adhesion and magnetic continuity between tiles. Interconnect 140 connects metallization layers to complete the electrical continuity of the coil. Extensions of the coil at either end form electrodes 150 (also referred to herein as contacts or leads).

It should be noted that the fabrication process can include the formation of two or more electrically independent coils or other electronic elements, disposed in any way desired, such as overlapping, non-overlapping, laterally distributed, and oriented in two or three dimensions within the magnetic tile stack. Optionally, additional components can be included at the interfaces between tiles, or in spaces within tiles; such components can include, for example, heat conduction elements, capacitive plates, and dielectric materials, as well as conductive pathways to form a circuit within the stack or to connect with off-stack circuit elements.

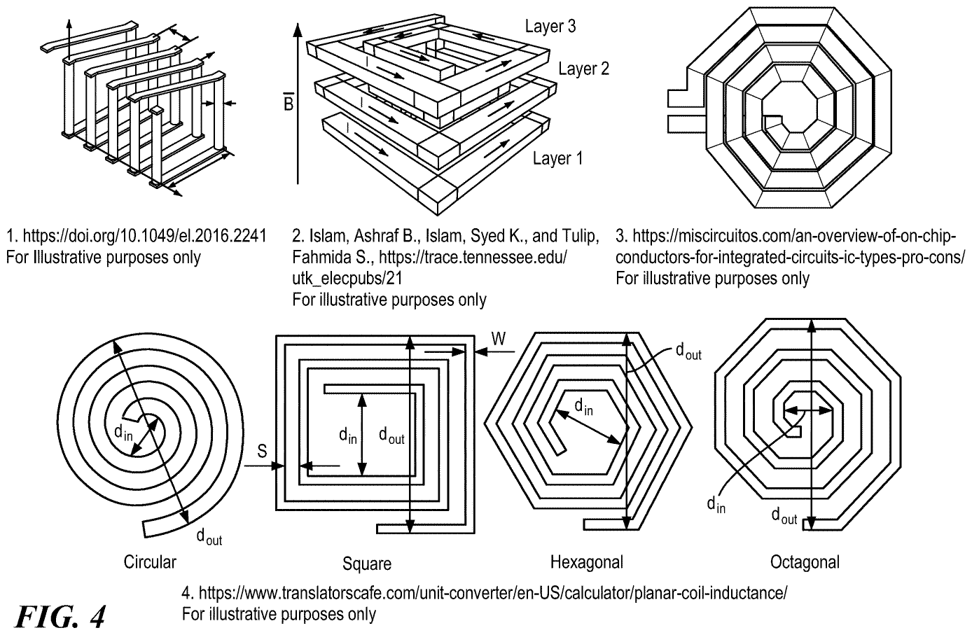

A key objective of the fabrication process is the integration of one or more three-dimensional metal coils within the stack of ferrite tiles. Conductivity is maintained between metallization layers through the use of vias. FIG. 4 depicts various coil designs that can be employed, including a solenoid and a variety of integrated coil configurations, such as circular, square, hexagonal, and octagonal. Coils are preferably formed from a series of segments that approximate a traditional wire coil structure. The vertical dimension of coil structures can be as little as about 50 micrometers. The coil can be deposited into trenches prepared in the magnetic material tile, such as by lithography, or a ferrite-loaded paste can be screen printed over the coil. Both provide a flat surface for subsequent bonding to an adjacent tile, reduction in stress, and magnetic continuity between tiles.

The benefits of using wafer-bonding technology to fabricate inductor devices include small form factor, optionally rectangular form factor for high packing density on PCBs, high power handling capability, high frequency operation, and moderate cost of mass production. Waver bonding is particularly well-suited to interfacing with wide bandgap systems in a volume efficient packaging. Wafer bonding also avoids the use of the high temperatures required by other technologies, such as LTCC (requiring 960° C.), which makes it compatible with the inclusion, or exclusion, of organic polymer materials including flexible substrates. Wafer bonding only requires modest temperatures of up to about 320° C., optionally with elevated pressures, and can involve adhesives or other interface materials or avoid the use of adhesives and other interface materials by using direct bonding. The use of wafer bonding conditions also produces very precisely structured devices compared to devices fabricated using very high temperatures, where components such as conductors can diffuse or melt and alter their form.

An example of a wafer bonding process involves plasma activation, cleaning with deionized water, and wafer bonding in sequence using EVG bonding equipment (GEMINIFB_XT, EV Group, Melaka, Malay Peninsula). During the bonding process, dangling bonds and bonds between hydroxyl groups and water molecules form through plasma activation in a vacuum plasma chamber. The bonding process can be conducted in a bonding module via the following sequence. (1) The top wafer is transported to the location of the bonding gap using a vacuum chuck. (2) The top vacuum chuck uses an inner and an outer vacuum state. During contact for wafer bonding, the vacuum state of the inner region of the top wafer is released, while the vacuum state of the outer region of the wafer is maintained. The center region of the top wafer is then brought into contact with the bottom wafer using a center pin. (3) During contact, the vacuum state of the outer region is released. After wafer bonding, the bonded wafers can be annealed at 300° C. Wafer bonding can be used to join any two flat, mirror polished, clean surfaces with various crystallographic orientations and lattice constants. Typically, temperature, force, and/or an intermediate layer are used to facilitate bonding. Silicon direct, anodic, eutectic, thermocompression, and Cu-Cu bonding can be used.

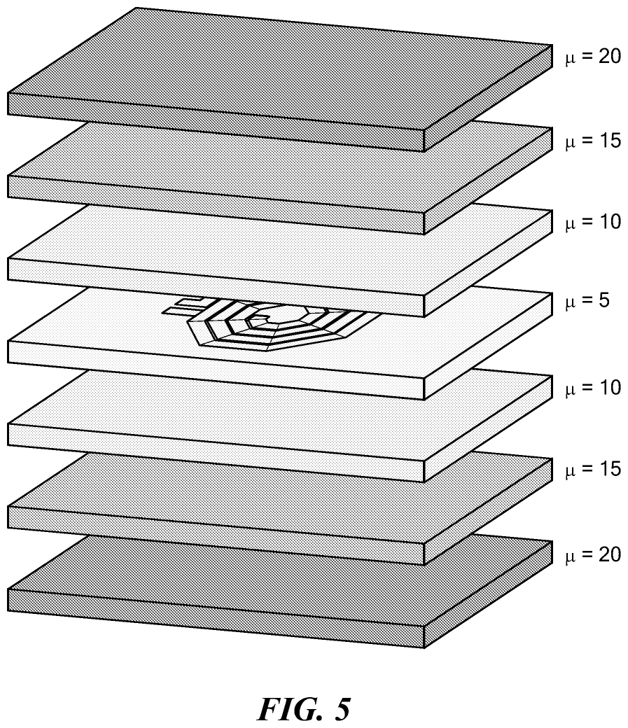

Another advantage of the use of wafer-bonded magnetic material tiles to form an inductor device is that the magnetic properties of tiles within the stack can be varied at will. For example, one or more gradients of magnetic permeability can be formed by using adjacent tiles with increasing or decreasing permeability in either direction through the stack. An example of this is shown in FIG. 5. This can be accomplished by selecting different magnetic materials for tiles according to the desired permeability at certain positions within the stack. Such gradients can be used to shape or focus the magnetic field within the device, in conjunction with the coil configuration. In such embodiments, the coil can be either two-dimensional (i.e., formed within a single metallization layer, see FIG. 5) or three-dimensional.

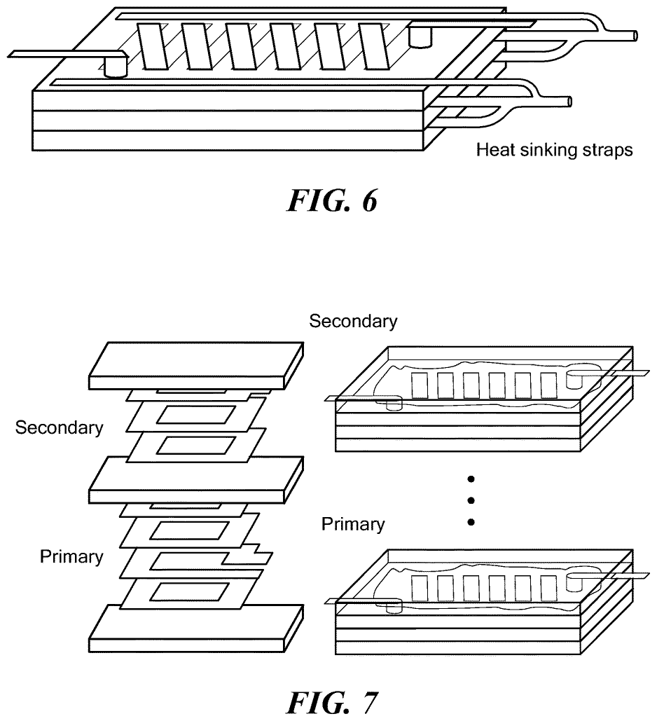

The availability of tile interfaces during fabrication makes possible the convenient addition of further device components at those interfaces. For example, heat-conducting materials, such as metals, graphene, carbon nanotubes, and the like, can be deposited as surface films or in trenches at tile interfaces or within interface layers to remove heat generated within the device for cooling. See an example shown in FIG. 6. Heat sinking straps or leads can be attached to structures covering a PCB or connected with heat radiating fins. Inductor devices having rectangular format can even be placed within such fins, and heat sinking leads connected to the fin for efficient cooling.

Two or more separate coils can be integrated into a single wafer-bonded inductor device to form a transformer. In such a transformer, the coils are embedded within a common stack of magnetic material tiles rather than being wound around a common magnetic core material. The coils will typically have different numbers of turns so as to form a step-up or step-down transformer, and the coils can be disposed in a stack above one another (see FIG. 7), or can be partially overlapping or non-overlapping.

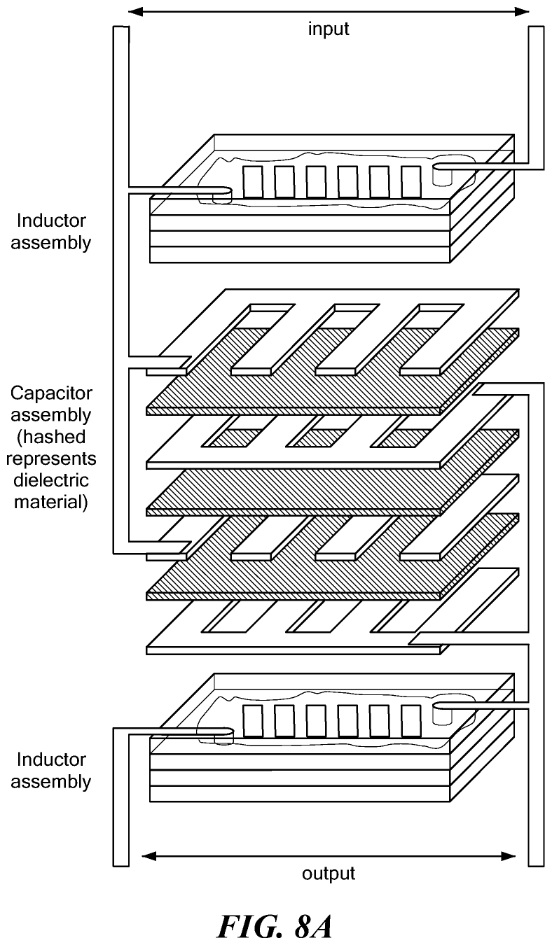

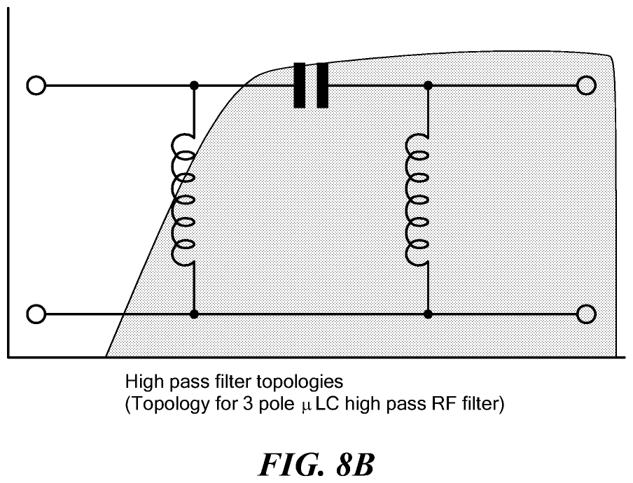

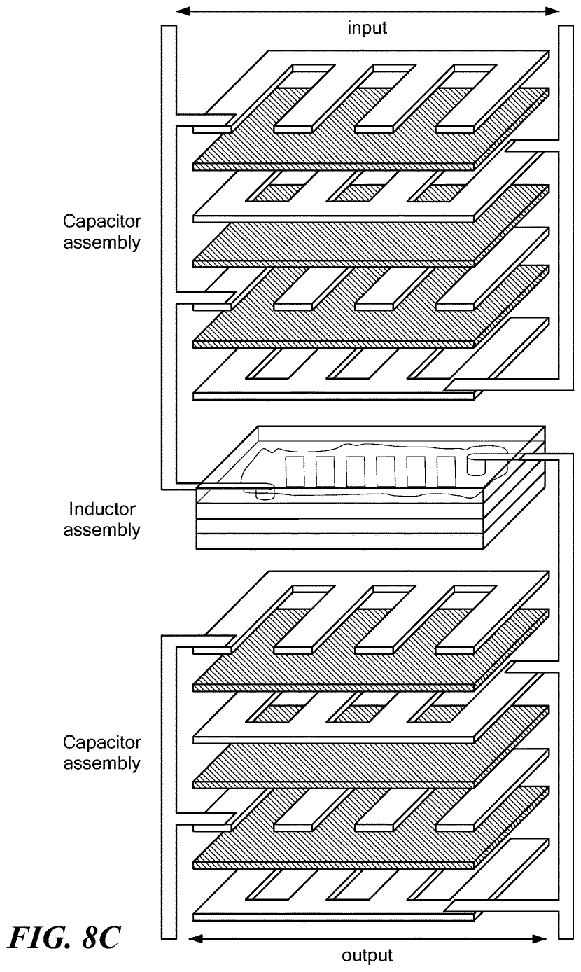

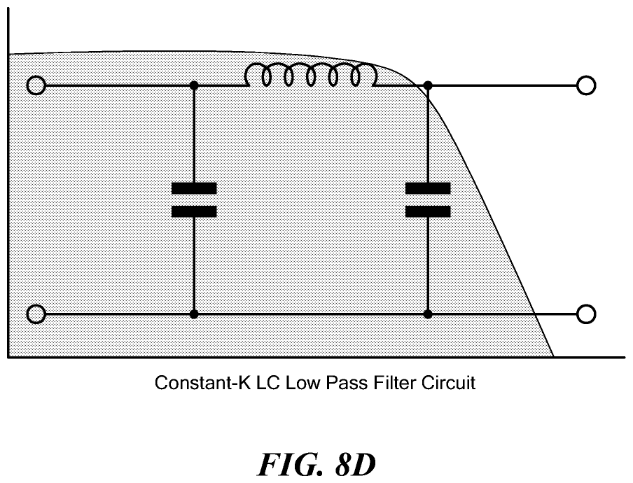

Capacitive plates and dielectric separator materials can be integrated at selected interfaces within a wafer-bonded inductor device of the present technology. Plates can be formed from planar metallic sheets that cover part or all of selected interfaces between magnetic tiles, and dielectric material can be used to form selected tiles within the stack, or portions of tiles, or deposited directly onto metallic capacitive plates. The plates can be connected by conductive metal pathways to form one or more capacitors within an inductor device. The inductor can be connected to the capacitor in series or in parallel to form an LC filter. FIGS. 8A-8D show example configurations for LC filters that can be made with the present technology. Capacitors are fabricated in a manner similar to inductors, and preferably using the same form factor, by bonding dielectric material tiles (e.g., containing or consisting of silicon dioxide, metal oxide, organic polymers) with metal plate and conductive path layers at the interfaces. Inductors and capacitors can be joined into single stack units, each forming an LC filter device.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of”or “consisting of”.

While the present invention has been described in conjunction with certain preferred embodiments, one of ordinary skill, after reading the foregoing specification, will be able to effect various changes, substitutions of equivalents, and other alterations to the compositions and methods set forth herein.

### REFERENCES

1. www.tdk-electronics.tdk.com/en/373562/tech-library/articles/applications-cases/applications-cases/thin-and-efficient-power-transmission/980554
2. M. H. Lim, J. D. van Wyk, F. C. Lee and K. D. T. Ngo, “A Class of Ceramic-Based Chip Inductors for Hybrid Integration in Power Supplies,” in IEEE Transactions on Power Electronics, vol. 23, no. 3, pp. 1556-1564, May 2008, doi: 10.1109/TPEL.2008.921180.
3. W. Bakalski, N. Ilkov, O. Dernovsek, R. Matz, W. Simburger, P. Weger, and A. L. Scholtz, “5-6.5 GHz LTCC power amplifier module with 0.3 W at 2.4 V in si-bipolar,” Electron. Lett., vol. 39, no. 4, pp. 375-376, Feb. 20, 2003.
4. D. Heo, A. Sutono, E. Chen, Y. Suh, and J. Laskar, “A 1.9-GHz DECT CMOS power amplifier with fully integrated multilayer LTCC passives,”IEEE Microw. Wireless Compon. Lett., 11, no. 6, p. 249, Jun. 2001.
5. R. Hahn, S. Krumbholz, and H. Reichl, “Low profile power inductors based on ferromagnetic LTCC technology,” in Proc. 56th Electron. Comp. Technol. Conf., May 30-June 2 2006, pp. 528-533.
6. T. Mikura, K. Nakahara, K. Ikeda, K. Furukuwa, and K. Onitsuka, “New substrate for micro DC-DC converter,” in Proc. 56th Electron. Comp. Technol. Conf., May30-June 2 2006, pp. 1326-1330.
7. K.W. Moon, S.H. Hong, H.J. Kim, and J. Kim, “A fabrication of DC-DC converter using LTCC NiZnCu ferrite thick film,” in Proc. IEEE Int. Magnetics Conf., Apr. 4-8, 2005, pp. 1109-1110.
8. ESL ElectroScience, “Thick-film materials and ceramic tapes from ESL ElectroScience,” Tech. Rep., 2008 [Online]. Available: www.electroscience.com
9. M. H. F. Lim, Z. Liang, and J. D. van Wyk, “Low profile integratable inductor fabricated based on LTCC technology for microprocessor power delivery applications,”IEEE Trans. Compon., Packag. Manufact. Technol., 30, no. 1, pp. 170-177, Mar. 2007.
10. D. S. Gardner, G. Schrom, F. Paillet, B. Jamieson, T. Karnik and S. Borkar, “Review of On-Chip Inductor Structures With Magnetic Films,” in IEEE Transactions on Magnetics, 45, no. 10, pp. 4760-4766, Oct. 2009, doi: 10.1109/TMAG.2009.2030590.
11. J. M. Boggetto, Y. Lembeye, J. P. Ferrieux, and Y. Avenas, “Micro fabricated power inductors on silicon,” in IEEE 33rd Annu. Power Electronics Specialists Conf., PESC 02, 2002, 3, pp. 1225-1229.
12. S. S. Mohan, M. D. M. Hershenson, S. P. Boyd, and T. H. Lee, “Simple accurate expressions for planar spiral inductances,” IEEE J. Solid-State Circuits, 34, pp. 1419-1424, 1999.
13. D. S. Gardner, A. M. Crawford, and S. X. Wang, “High frequency (GHz) and low resistance integrated inductors using magnetic materials,” in Proc. IEEE Int. Interconnect Tech. Conf., 2001, pp. 101-103.
14. B. Viala, S. Couderc, A. S. Royet, P. Ancey, and G. Bouche, “Bidirectional ferromagnetic spiral inductors using single deposition,” IEEE Trans. Magn., 41, pp. 3544-3549, 2005.
15. A. M. Crawford, D. Gardner, and S. X. Wang, “High-frequency microinductors with amorphous magnetic ground planes,” IEEE Trans. Magn., 38, pp. 3168-3170, 2002.
16. M. Yamaguchi, K. Suezawa, K. I. Arai, Y. Takahashi, S. Kikuchi, Y. Shimada, W. D. Li, S. Tanabe, and K. Ito, “Microfabrication and characteristics of magnetic thin-film inductors in the ultrahigh frequency region,” J. Appl. Phys., 85, pp. 7919-7922, 1999
17. M. Yamaguchi, M. Baba, and K. I. Arai, “Sandwich-type ferromagnetic RF integrated inductor,” IEEE Trans. Microw. Theory Tech., 49, pp. 2331-2335, 2001.

1. A wafer-bonded inductor, comprising:
(i) a non-magnetic substrate;
(ii) two or more magnetic layers disposed as a stack on the substrate;
(iii) a three dimensional metallic coil structure disposed within the stack; and
(iv) a first contacts electrically connected to a first end of the coil structure and a second contact electrically connected to a second end of the coil structure.

2.-23. (canceled)

24. A wafer-bonded transformer, comprising:
(i) a first wafer-bonded inductor of claim 1;
(ii) a second wafer-bonded inductor of claim 1, wherein the non-magnetic substrate of the second wafer-bonded inductor is disposed on an uppermost magnetic layer of the first wafer-bonded inductor; and
(iii) a top non-magnetic substrate disposed on an uppermost layer of the second wafer-bonded inductor.

25. A method of fabricating a wafer-bonded inductor, the method comprising the steps of:
(a) providing a non-magnetic substrate, a plurality of tiles, the tiles comprising or consisting of a magnetic material, a conductive metal, and optionally an interface material;
(b) bonding a first of said tiles to the substrate;
(c) depositing the conductive metal to form a first patterned metallization layer on a surface of the first tile opposite the substrate;
(d) optionally applying the interface material to coat the first tile and first patterned metallization layer;
(e) forming vias in a second of said tiles according to pattern suitable for alignment with selected structures of the first patterned metallization layer;
(f) bonding the second tile to the first tile, whereby the vias align with said selected structures;
(g) depositing the conductive metal on a surface of the second tile opposite the first metallization layer, whereby the metal fills the vias, forms a second patterned metallization layer, and forms a continuous conductive pathway between the first metallization layer and the second metallization layer;
(h) repeating steps (d)-(g) to deposit a third and optionally further tiles, vias, and metallization layers, thereby forming a stack of magnetic material tiles and a three-dimensional coil structure embedded within the stack of magnetic material tiles, with first and second exposed electrical contacts electrically connected with first and second ends of the coil structure.

26. The method of claim 25, wherein the plurality of tiles each comprise or consist of a magnetoceramic material, such as a spinel, ferrite, garnet, hexaferrite, or any combination or composite thereof.

27. The method of claim 26, wherein the plurality of tiles each comprise or consist of a high density ferrite material comprising a continuous crystalline structure, such as a ferrite material having a density of at least 95%, at least 98%, or at least 99% of a theoretical maximum for the ferrite material.

28. The method of claim 26, wherein the ferrite is Ni₁₋ₓZnₓFe₂O₄ or Mn₁₋ₓZnₓFe₂O₄.

29. The method of claim 26, wherein the magnetoceramic material comprises Cu, Ti, Mg, Co, Li, or any combination thereof.

30. The method of claim 25, wherein the plurality of tiles comprises magnetic materials having different magnetic permeabilities.

31. The method of claim 30, wherein the different magnetic permeabilities of adjacent tiles in the stack form a gradient from lower magnetic permeability at a center of the stack to higher magnetic permeability towards top and bottom of the stack, or from higher magnetic permeability at the center of the stack to lower magnetic permeability towards top and bottom of the stack.

32. The method of claim 25, wherein the conductive metal is selected from the group consisting of gold, silver, copper, aluminum, chromium, titanium, platinum, palladium, and combinations thereof.

33. The method of claim 25, wherein the interface layer comprises an adhesive, such as a polymer adhesive, a magneto-dielectric paste that has both permeability and permittivity, and/or magnetic or non-magnetic particles, such as ferrite nanoparticles.

34. The method of claim 33, wherein step (d) is performed and the interface layer is formed using a powder or paste comprising a ferrite.

35. The method of claim 25, wherein the bonding of step (b) and/or step (f) in at least one instance comprises direct wafer bonding without the use of an interface material, adhesive material, or interface layer.

36. The method of claim 25, further comprising depositing one or more additional metallic structures disposed between the magnetic tiles, the additional metallic structures not in electrical contact with said coil structure.

37. The method of claim 36, wherein the additional metallic structures are configured as heat sink structures, and wherein the heat sink structures are coupled with extensions leading out of the stack and configured for coupling to one or more heat disposal structures.

38. The method of claim 36, wherein the additional metallic structures are configured as two sets of capacitive plates, each set comprising one or more capacitive plates electrically connected to a common contact.

39. The method of claim 25, further comprising fabricating a non-metallic encapsulation layer on the stack of magnetic layers, wherein the encapsulation layer covers the conductive metallic structures and magnetically isolates the three dimensional metallic coil structure.

40. The method of claim 25, wherein the tiles and the resulting wafer-bonded inductor have a rectangular form.

41. A circuit or device comprising the wafer-bonded inductor of claim 1.

42. (canceled)
